(19) United States
(12) Patent Application Publication
(10) Pub. No.: US 2017/0198917 A1
(43) Pub. Date: Jul. 13, 2017

(54) KAMADO STYLE COOKER WITH IMPROVED CONTROL MEANS

(71) Applicant: W.C. BRADLEY CO., Columbus, GA (US)

(72) Inventors: BRAD GILLESPIE, Midland, GA (US); ANTHONY HAMILTON, Hamilton, GA (US)

(21) Appl. No.: 15/352,167

(22) Filed: Nov. 15, 2016

Related U.S. Application Data
(60) Provisional application No. 62/277,267, filed on Jan. 11, 2016.

(51) Int. Cl. F24B 1/02; A47J 37/07

(52) U.S. Cl. CPC F24B 1/028; A47J 37/07; F24B 1/026

(57) ABSTRACT

A cooker with a body having separable upper and lower portions with an exhaust vent and an intake port, respectively. A fuel grate is inside the lower portion. A diffuser interposes the fuel grate and the air intake port. A snorkel provides an air pathway from the air intake port to a location outside the cooker body and above the fuel grate.

### CROSS-REFERENCE TO RELATED CASES

This application claims the benefit of U.S. provisional patent application Ser. No. 62/277,267, filed on Jan. 11, 2016, and incorporates such provisional application by reference into this disclosure as if fully set out at this point.

### FIELD OF THE INVENTION

This disclosure relates to solid fuel cookers in general and, more specifically, to an improved airflow mechanism for outdoor cookers.

### BACKGROUND OF THE INVENTION

Various charcoal and solid fuel cookers have been on the market for decades, if not longer. Some of these are provided with adjustable airflow mechanisms or dampers. Often, such dampers or valves are provided at a single location (e.g., the lid). However, such a configuration limits fine control over airflow that may be needed to precisely control temperatures and cooking parameters. Generally, airflow is the primary means of controlling a solid fuel cooking fire since the fuel supply cannot be easily adjusted once ignited.

What is needed is a system and method for addressing the above, and related, issues.

### SUMMARY OF THE INVENTION

The invention of the present disclosure, in one aspect thereof, comprises a cooker with a body having separable upper and lower portions with an exhaust vent and an intake port, respectively. A fuel grate is inside the lower portion. A diffuser interposes the fuel grate and the air intake port. A snorkel provides an air pathway from the air intake port to a location outside the cooker body and above the fuel grate.

In some embodiments, the cooker further comprises a fire bowl inside the lower portion on an opposite side of the fuel grate from the diffuser. A cooking grate may be located above the fire bowl. In some embodiments, the diffuser presents a floor proximate the intake port that forces intake air radially away from the intake port inside the cooker body before it reaches the fuel grate. The diffuser may provide a plurality of openings above the floor admitting air to the fuel grate. The diffuser may provide a cylindrical section above the floor through which the plurality of openings is defined. The diffuser may have a curved section joining the cylindrical section to the floor to define an ash pan.

In some embodiments, the upper and lower portions join at a midportion of the cooker body and the snorkel terminates with an adjustable intake valve proximate the midportion. The snorkel may terminate proximate a side shelf proximate the midportion of the cooker body. An adjustable exhaust valve may also be provided at the exhaust vent.

The invention of the present disclosure, in another aspect thereof, comprises a cooker with a lower portion of a cooker body defining an air intake port through a bottom thereof. A diffuser is proximate the air intake presenting a solid surface toward the air intake port that disperses air entering the port laterally away from the port. A fuel grate is inside the lower portion of the cooker body above the diffuser and a cooking grate is above the fuel grate. An upper portion of the cooker body selectively closes on the lower portion covering the cooking grate and opens from the lower portion exposing the cooking grate. A plurality of openings defined in walls of the diffuser above the solid surface diffuse air to an area below the fuel grate.

Some embodiments further comprise a snorkel that provides a closed air path between the air intake port and an area proximate an upper end of the lower portion of the cooker body. A fire bowl may interpose the fuel grate and the cooking grate. An adjustable exhaust vent may be located on the upper portion of the cooker body. An adjustable air intake vent may be located on the snorkel opposite the air intake port on the lower portion of the cooker body. The air intake vent may be located at approximately a height at which the upper portion of the cooker body joins the lower portion of the cooker body.

The invention of the present disclosure, in another aspect thereof, comprises a cooker having a lower portion of a cooker body defining an air intake port through a bottom thereof. A fire bowl is suspended in the lower portion of the cooker body that has walls that are spaced apart from an adjacent portion of the lower portion of the cooker body and having a contour that mirrors the adjacent portion of the cooker body. A fuel grate at a bottom of the fire bowl is suspended above the air intake port. A cooking grate is suspended proximate a top of the fire bowl. An upper portion of the cooker body selectively covers the cooking grate by closing against the lower portion of the cooker body. A snorkel defines a closed air path from the air intake port defined in the bottom of the lower portion of the cooker body to a vertical height proximate a midportion of the cooker body where the upper portion connects to the lower portion.

Some embodiments further comprise a diffuser below the fuel grate that has a solid plate that directs intake air from the intake port radially away from the intake port. The diffuser may further comprise upright walls connected to and proceeding upwardly from an outer edge of the flat plate, the upright walls defining a plurality of perforations that admit intake air to the fuel grate. The snorkel may provide an adjustable intake vent on an end thereof opposite the air intake port on the lower portion of the grill body. The air intake vent may be vertically superior to the fire bowl.

### BRIEF DESCRIPTION OF THE DRAWINGS

FIG. 1 is a perspective partial cutaway view of a kamado style cooker.

FIG. 2 is a perspective view of a kamado style cooker according to aspects of the present disclosure.

FIG. 3 is a frontal view of a kamado style cooker according to aspects of the present disclosure.

FIG. 4 is a side perspective view of a kamado style cooker according to aspects of the present disclosure.

FIG. 5 is a frontal cutaway view of a kamado style cooker according to aspects of the present disclosure.

FIG. 6 is a partial exploded view of a kamado style cooker according to aspects of the present disclosure.

FIG. 7 is a side cutaway view of a computational fluid dynamics (CFD) model of a kamado style cooker without an internal diffuser operating in a calm environment.

FIG. 8 is a side cutaway view of a CFD model of a kamado style cooker according to aspects of the present disclosure operating in a calm environment.

FIG. 9 is a side cutaway view of a CFD model of a kamado style cooker without an internal diffuser and snorkel operating in a four mile per hour wind.

FIG. 10 is a side cutaway view of a CFD model of a kamado style cooker according to aspects of the present disclosure operating in a four mile per hour wind.

### DETAILED DESCRIPTION OF THE PREFERRED EMBODIMENTS

Charcoal cookers consisting of a two part insulated ellipsoid have been sold and described as kamado cookers. These products are described, for example, in US Patent Application Publication nos. 2009/0308373, 2010/0258105, and 2011/0283990, hereby incorporated by reference, and in various promotional literature from a number of manufacturers.

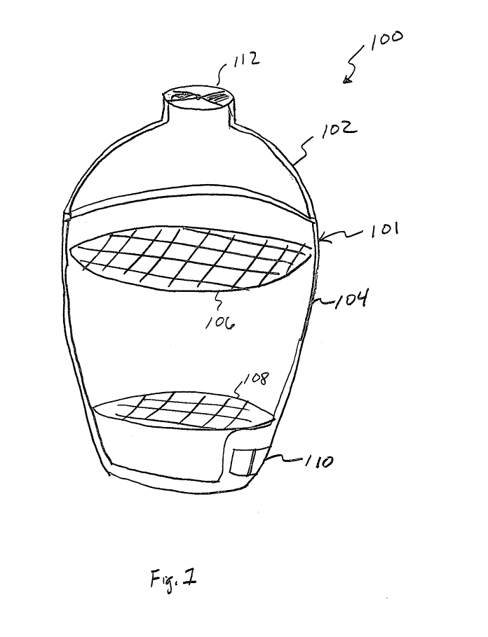

In one example, as shown in the partial cutaway perspective view of FIG. 1, a kamado cooker 100 may comprise a generally ellipsoid body 101 having an upper portion 102 hingedly attached to a lower portion 104. The lower portion 104 may contain a cooking grate 106 above a fuel grate 108. Airflow, and therefore cooking characteristics, may be controlled within the cooker 100 by adjustment of a lower vent 110 on the lower portion 104 of the cooker body 100, and an upper vent 112 on the upper portion 102. In the embodiment shown, the lower vent 110 is an intake vent and may be of a type that is slidingly adjustable. The upper vent 112 is an exhaust or outlet vent, and may be a butterfly damper. Given a certain load of solid fuel (e.g., charcoal) and a certain amount of food, the lower (intake) vent 110 and the upper (outlet) vent 112 are adjusted to give desired cooking results.

With the grill of FIG. 1, adjustment of the outlet vent 112 is simple and easy to do as the device is at a level between waist and shoulder for most individuals in a standing position. However adjustment of the intake vent 110 is more difficult, as it must be accessed by bending, kneeling, or squatting. With the grill 100, the position of the inlet 110 and outlet 112 cannot be seen at the same time, and there is no clear relationship between the opening of the outlet and intake.

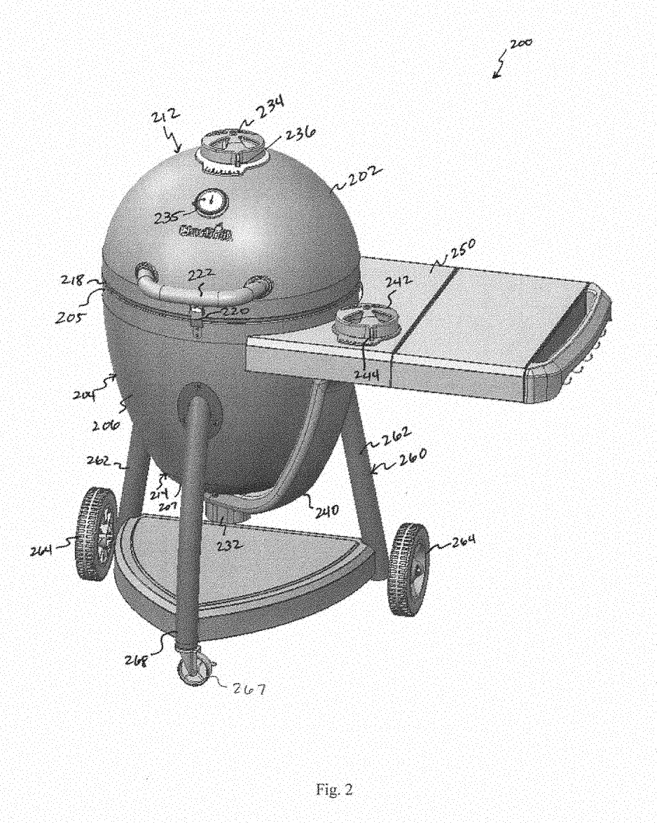

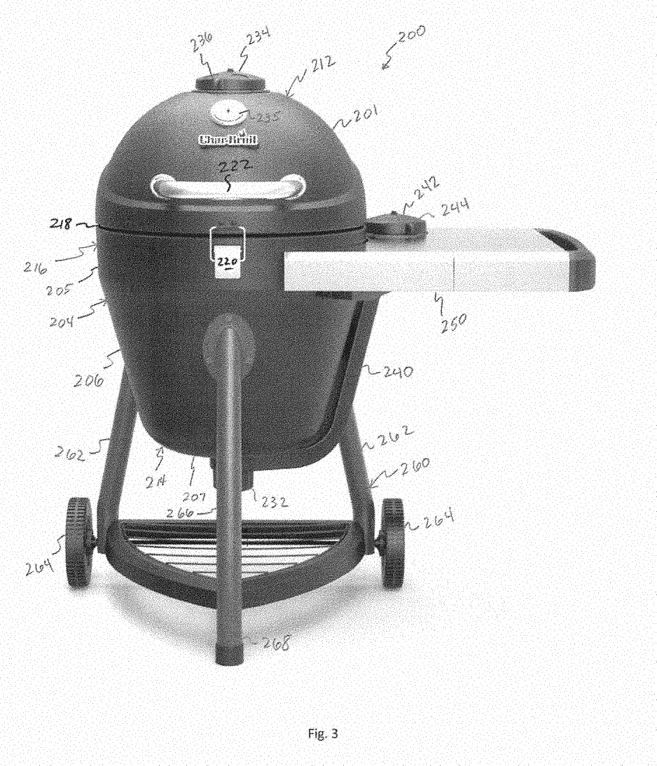

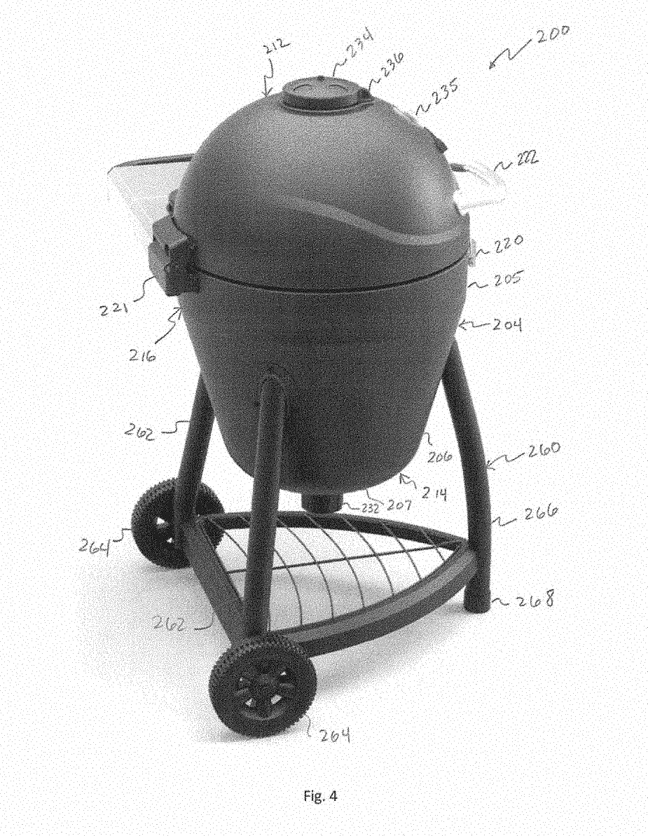

Referring now to FIG. 2, a perspective view of a kamado style cooker 200 according to aspects of the present disclosure is shown. The cooker 200 may also be seen in frontal view in FIG. 3 and in side perspective view in FIG. 4.

The cooker 200 provides a body 201 which may be ellipsoid or have another general shape. The body 201 may comprise an upper portion 202 hingedly affixed to a lower portion 204. The body 201, considered as an ovoid, may have a lower, more sharply pointed end 214 and an upper, less sharply pointed end 212. In some embodiments, as may be better seen from the frontal view of FIG. 3, the body 201 may comprise a domed or parabolic upper end 212 and an at least partially frustoconical lower end 214. The upper portion 202 and/or the lower portion 204 may also be at least partially cylindrical proximate a midportion 216 of the body 201. As such, in some embodiments, the lower portion 204 of the body 201 comprises a cylindrical section 205 above a frustoconical section 206 having a flat bottom plate 207. In some embodiments, the frustoconical section 206 may be parabolic, and may or may not be perfectly flat on bottom plate 207.

The upper portion 202 and lower potion 204 of the body 201 may have an interior profile that mirrors or substantially mirrors the outer shape. In this respect, both the upper portion 202 and lower portion 204 of the body 201 may be thought of as shells defining a hollow interior of the body 201 that may be accessed by opening the two portions 202, 204. In embodiments where the body 201 has an overall ovoid shape, a domed/frustoconical shape, or other similar shape, heated gases from the fire or combustion occurring in the lower portion 204 may expand as they rise up and into the upper portion 202. Further, the upper end 212 and/or upper portion 202 being larger than the lower end 214 and/or lower portion 204 allows for greater cooking surface area as cooking grates may be located proximate the midportion 216 of the body 201 and/or inside the upper portion 202. The midportion 216 may be considered to comprise parts of either or both the upper portion 202 and lower portion 204.

Where the upper portion 202 and lower portion 204 of the body 201 meet, a gasket or seal 218 may be provided. The seal 218 may be considered to occupy the midportion 216. The seal 218 prevents escape of heated cooking gases where they are needed most for cooking purposes and also helps to prevent interior cold spots. The seal 218 may comprise silicon, Nomex® or another material tolerant of high temperatures.

As best seen in FIG. 4, a hinge 221 may be affixed to both the upper portion 202 and the lower portion 204. The upper portion 202 may act as a lid to the lower portion 204 allowing access to the internals of the cooker 200. The hinge 221 may be situated toward the rear of the cooker 200 such that it may be easily opened from the front. A latch 220 may be placed opposite the hinge 221 on the front of the cooker 200 to allow the upper portion 202 to be retained closed against the lower portion 204. The seal 218 may be somewhat malleable such that a slight deformation occurs when the upper portion 202 is tightly closed and latched against the lower portion 204. This may help to insure a leak resistant and heat retentive connection between the upper portion 202 and lower portion 204 during operation.

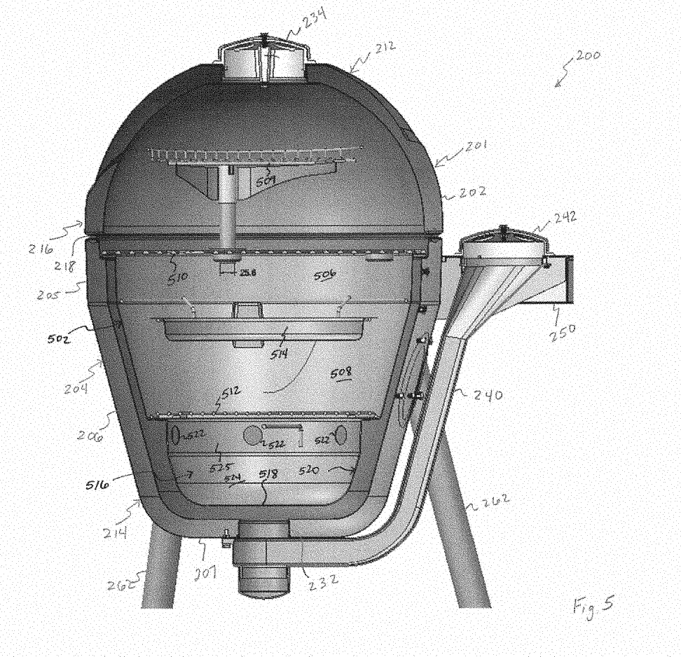

A handle 222 may be provided on or near the front of the upper portion 202 of the cooker body 201 to aid in raising and lowering the upper portion 202 as a lid. An externally readable thermometer 235 may be provided on the upper portion 202 or in another conveniently viewable location. The thermometer 235 may be place proximate the elevation of internal cooking grates (shown in FIG. 5 discussed below) in order to provide an accurate temperature reading where cooking occurs inside the cooker 200.

As described above, airflow through a kamado style cooker may be from bottom to top to take advantage of the natural tendency for combustion products and heated gases to rise. In some embodiments of the present disclosure a top exhaust vent 234 may be provide at or near the top most portion of the upper end 212 of the upper portion 202. The exhaust vent 234 may be of a butterfly type design such that rotation of the vent about a central axis opens or closes the vent. A graduated dial and pointer 236 may be provided in a conveniently viewable location, such as the upper end 212, to allow a user to quickly and easily make precise adjustments of the exhaust vent 234. In some embodiments, the dial 236 may be easily viewable and accessibly placed near the thermometer 234.

Air flow being generally from the bottom 214 of the cooker 202 to the top 212, a lower port 232 is provided into the lower portion 204 of the body 201. The lower port 232 functions as an intake port. The lower port 232 may be at or near a lower portion of the lower end 214 of the lower portion 204. As discussed above, previous kamado style cookers have required a user to bend over or reach down to the bottom of the cooker to operate or access any valve mechanism on a lower air intake port. In some embodiments of the present disclosure, a snorkel 240 spans from the port 232 to a convenient location outside the cooker body 201 and elevated to a more convenient location for placement of an intake vent 242.

The length of the snorkel 240 can vary in different embodiments but it may conveniently terminate near the midportion 216 of the body 201. This provides placement of the intake vent 242 near other controls of the cooker 200 such as the latch 220 and handle 222. The vent 242 may be a butterfly valve type vent such that air intake may be precisely controlled. The vent 242 may provide a graduated dial and pointer 244 similar to the dial and pointer 236 of the exhaust vent 234. The snorkel 240 may begin directly below the lower portion 204 of the body 201 but it may angle slightly toward the front of the body 201 to further reduce the need to reach to access the intake vent 242. The snorkel 240 may have an internal cross section of about 5 square inches. In some embodiments, the internal cross sectional area of the snorkel 240 is configured to be at least as great as the maximum open intake area of the intake vent 242 such that the vent 242 is always the primary limiter of intake air.

The snorkel 240 may follow the outer contours of the lower portion 204 of the cooker body 201 along its path. In some embodiments, the snorkel 240, while following the general outer contours of the lower portion 204, may remain spaced apart from the surface of the lower portion 204. This allows for expansion and contraction of the body 201 in response to heating and cooling cycles without damage to either the body 201 or the snorkel 242.

In operation, the upper portion 202 may spend a significant amount of time closed and latched to the lower portion 204. In such case, the exhaust vent 234 will always remain the highest point at which exhaust gasses can escape ensuring an acceptable “draw” of air into the snorkel 240 and thus through the body 201 in the proper direction (e.g., bottom to top). Naturally, when the lid or upper portion 202 is hinged open, exhaust gases and combustion products can simply escape through and around any cooking grates placed near the midportion 216 or the seam between the upper portion 202 and lower portion 204. Therefore, in some embodiments, the intake vent 242 may be placed at least slightly below the midportion 216 or where the upper portion 202 meets the lower portion 204 of the body 201. This will tend to keep airflow in the proper direction even when the body 201 is not latched closed. On the other hand, instead of or in addition to this configuration, the vent 242 may be adjusted closed when the upper portion 201 is opened.

The cooker 200 may be equipped with one or more side shelves 250. The side shelf 250 may provide a convenient location for termination of the snorkel 240 and/or placement of the intake vent 242. An opening through the side shelf 250 may provide passage for the snorkel 240 and/or vent 242 from the bottom to a top side of the side shelf 250. The dial and pointer 244 may be arranged so as to the viewable and adjustable from the top of the side shelf 250.

The cooker 200 may also provide other convenience features. The cooker 200 may be mounted to a platform 260. The platform 260 may be a three legged design with wheels on one or more legs. As shown, back legs 262 may be provided with wheels 264. In some embodiments, as shown in FIG. 2, a front leg 266 may be provided with a lockable caster 267. In other embodiments, the front leg 266 terminates with a foot 268 as shown in FIGS. 3-4. With the caster 267 unlocked, the cooker 200 may be wheeled into position and the caster 267 locked. In those embodiments with the foot 268 instead of the caster 267, when the latch 220 is closed, the handle 220 may be used to lift the front of the cooker 200 for movement via the attached wheels 264.

Referring now to FIG. 5 a frontal cutaway view of a kamado style cooker according to aspects of the present disclosure is shown. It can be seen that the walls of the upper portion 202 and lower portion 204 of the body 201 have a greater thickness than non-kamado style grills. The walls may have a multilayer or insulated construction, or may be made from a thicker ceramic or earthenware construction. The cookers of the present disclosure are designed to cook primarily from a closed configuration and produce more even, reliable, and high temperatures than other solid fuel (e.g., charcoal) grills.

Within the lower portion 204 is a fire bowl 502. The fire bowl 502 may have a metallic construction or be constructed from other heat resistant materials. The fire bowl 502 may be configured to provide a cooperating contour with the inside shape of the lower portion 204. The fire bowl 502 may be cylindrical, parabolic, or frustoconical. The fire bowl may have an upper cylindrical portion 506 and a lower frustocontical portion 508 as shown in FIG. 5 to mirror the overall shape of the lower portion 204 of the body 201. The fire bowl 502 may be offset slightly from the interior of the lower portion 204 such that there is no contact (or substantially no contact) between the outer surface of the fire bowl 502 and the inner wall surfaces of the lower portion 204 of the body 201. This serves to diminish heat loss from the fire bowl 502 through the body 201.

The fire bowl 502 may terminate on an upper portion thereof at or near the midportion 216 of the body 201. The fire bowl 502 may terminate at or slightly below the junction between the lower portion 204 and upper portion 202 of the body 201. A cooking grate 510 may be situated where the fire bowl 502 ends. The cooking grate 510 may therefore be accessible proximate the junction between the upper portion 202 and lower portion 204 of the body 201 and readily accessible when the upper portion 202 is hinged away or opened from the lower portion 204. The cooking grate 510 may have a circular shape and occupy substantially all of the cross section of the opened cooker body 201.

Affixed to the cooking grate 510 and/or the upper portion 202 or lower portion 204 may be a warming rack 509. The warming rack 509 may operate at a slightly lower temperature than the cooking grate 510 since it is slightly further from the fire bowl 502. However, with a kamado style cooker 200 as shown it may still reach temperature high enough to cook rather than just warm, particularly where the upper portion 202 is latched to the lower portion 204.

At a lower portion or bottom of the fire bowl 502, substantially deep within the lower portion 204 of the body 201 is a fuel grate 512. The fuel grate 512 serves as a platform for the combustion of a solid fuel (e.g., wood or charcoal) for heating the interior of the cooker body 201. The depth of the fuel grate 512 from the cooking grate 510 may vary depending upon the overall size of the cooker 200. However in some embodiments the fuel grate 512 is relatively deep within the lower body portion 204 so that the heat from combustion of the fuel can heat, by radiation and convection, a substantial portion of an inside wall of the fire bowl 502 such that heat will be radiated to the food on the cooking grate 510 from the sides of the fire bowl 502 as well as directly from fuel on the fuel grate 512. Therefore, in various embodiments, a distance from the cooking grate 510 to the fuel grate 512 may be at least 50% of a diameter of the cooking grate 510.

Interposing the fuel grate 512 and cooking grate 510 may be a drip pan 514. The drip pan 514 is intended to capture fats and other liquid byproducts of the cooking process dripping from the cooking grate 510 during cooking. This reduces internal flame ups while giving the fats and other liquids a chance to at least partially gasify into smoke or other products to enrich the flavor of the food being cooked. In other embodiments, a porous stone can be used instead of or in addition to the drip pan 514 to enhance smoke and flavor.

Affixed to the fire bowl 502, below the fuel grate 512, is a combination air diffuser and ash pan 516. As a diffuser, the device 516 prevents air from the intake port 232 from blowing directly to the fuel grate 512 and creating hotspots or causing an excess of ashes or sparks from reaching the food grate 506. A lower floor 518 of the diffuser 516 may be solid and immediately face, or be situated above, the intake port 232. The intake air is forced to sides 520 of the diffuser 516 where it may enter the diffuser in a slower and more controlled fashion via number of radial perforations or openings 522.

The sides 520 of the diffuser 516 may have a cylindrical section 525 and a sloped or curved section 524. The openings 522 may be defined in the cylindrical section 525 to further promote even air flow into the diffuser 516 and to the fuel grate 512. The sides or wall 520 of the diffuser 520 may be substantially vertical at the cylindrical section 525. The sloped section 524 may be partly parabolic and/or frustoconical and joins the sides 520 of the diffuser 516 to the floor 518 of the diffuser 518. The openings 522 into the diffuser may be spaced evenly around the cylindrical section 525. Depending upon the size of the openings 522 five to ten of these may be provided.

As stated above, the diffuser 516 also functions as an ash pan. With the perforations or openings 522 confined to the upper cylindrical portion of the diffuser 525, the lower curved portion 524 and floor 518 may be of an solid or unperforated construction to effectively retain ash resulting from consumed fuel on the fuel grate 512. Once ash is trapped in the lower portions of the diffuser 516 it is unlikely to be disturbed even in conditions of high air flow into the cooker 200 since the diffuser holes 522 are superior to where the ash is collected.

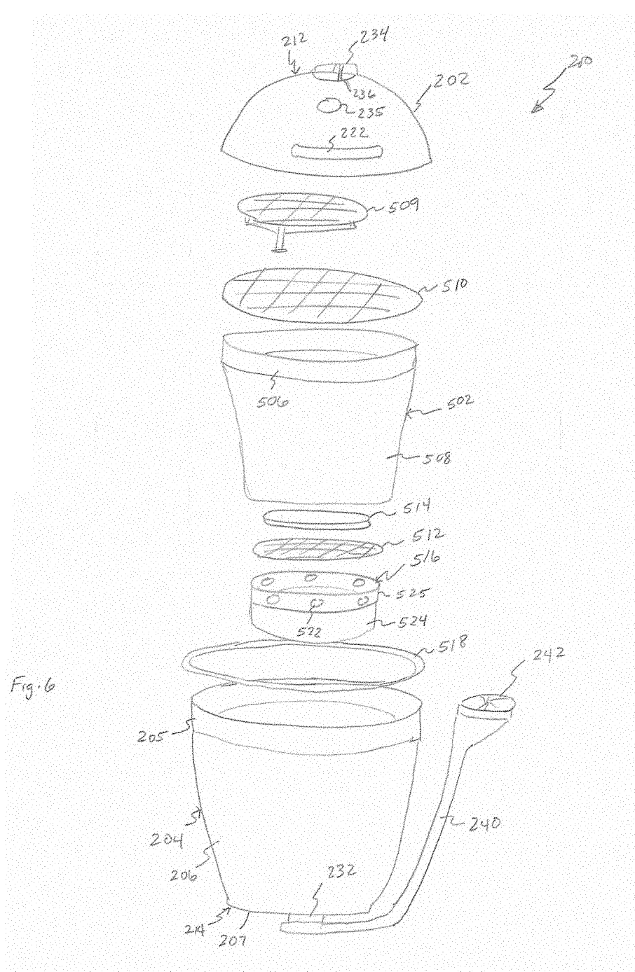

Referring now to FIG. 6, a partial exploded view of the kamado style cooker 200 is shown. For clarity, platform 260, side shelf 250, latch 220, and hinge 221 are omitted from FIG. 6. FIG. 6, together with FIG. 5, illustrate how the components of the cooker 200 nest or stack together to create the operational configuration of FIG. 5. The cross section of the components such as the upper portion 202, low portion 204, diffuser 516, and fire bowl 502 may be circular or round to promote the most even heating and air flow through the cooker 200.

The lower portion 204 contains the diffuser 516 suspended very low therein, with the floor 518 of diffuser 516 close, yet spaced apart, from the port 232 and the inside walls of the lower portion 204. Immediately above the diffuser 516 is the fuel grate 512. Most or all of the air supply to the fuel grate 512 is from the diffuser 516 feeding air through openings 522 to an area below the fuel grate 512.

The fire bowl 502 is also immediately adjacent to the diffuser 516 and proceeds upwardly therefrom through the lower portion 204 of the cooker body 201. The cylindrical portion 506 and/or the frustoconical portion 508 of the fire bowl 502 may mirror the shape of the inner portion of the lower portion 204 of the body 201 through which it runs. The fire bowl 502 may be in close proximity to the walls of the lower portion 204 yet remain spaced apart (except for mounting or suspending hardware) to limit heat transfer to the walls of the lower portion 204. The fire bowl 502 may have a lip 504 upon which the fuel grate 512 rests. In some embodiments the lip 504 connects to or attaches to the diffuser 516 such that air intake to the fuel grate 512 is limited to that air that flows through the openings 522 of the diffuser 522.

The drip pan 514 may be contained within the fire bowl 502 to sit between the cooking grate 510 and the fuel grate 512. The drip pan 514 may be wide enough to cover substantially all of the diffuser 516 and possibly the fuel grate 512 but will not span the entire width of the fire bowl 502 where it is situated in order that the heated gases and combustion products may pass by to the cooking grate 510 and beyond.

The cooking grate 510 may rest on an inner lip 505 defined near the midportion 216 of the body 201, on an upper edge of the lower portion 204 of the body 201. The cooking grate 510 is generally at or above the highest level the fire box 502 since the majority of heat and gas comes through the fire bowl 502. Above the lip 505 and the cooking grate 510, the seal 218 may be retained between the upper portion 202 and lower portion 204 at the joint therebetween. The seal 218 may be captive to either the upper portion 202 or the lower portion 204 or may be a two part seal such that both the upper portion 202 and lower portion 204 retain part of the seal 218 when the portions are separated or opened.

The warming rack 508 may attach to the cooking rack 510 and be elevated beyond the interior of lower portion 204 into upper portion 202. Items on the warming rack may cook or warm slower than those on the cooking grate 510 due to the increased distance from the fuel grate 512 and fire bowl 502. Proximity to the exhaust vent 234 may also serve to decrease temperatures on or near the warming rack 509.

The snorkel 240 provides an air pathway from the intake port 323 on the bottom plate 207 of the lower portion 204 of the body 201. The snorkel may traverse from this bottom most vertical location of the lower portion 204 to a position having substantial higher vertical elevation such that it is easy reached by a user for manipulation of the adjustable intake vent 242. The some embodiments, the vertical elevation for the intake vent 242 is higher than that of the diffuser 516. In some embodiments, the elevation is higher than that of the fuel grate 512. In some embodiments, the elevation of the intake vent is at or slightly below that of the top most portion of the lower portion 204 of the body 104 to help prevent reversal of gas flow though the lower portion 204 of the body 201 when the upper portion 202 is opened. Further to this concern, in some embodiments, the upper most elevation of the snorkel 240 and/or the vent 242 is at or slightly below the upper most elevation of the top of the fire bowl 502.

The air pathway defined by the snorkel 240 may be closed or substantially closed. That is, it may provide all or substantially all of the intake air reaching the port 232 and entering into the lower portion 204 of the body 201 when the body 201 closed for cooking or other operation.

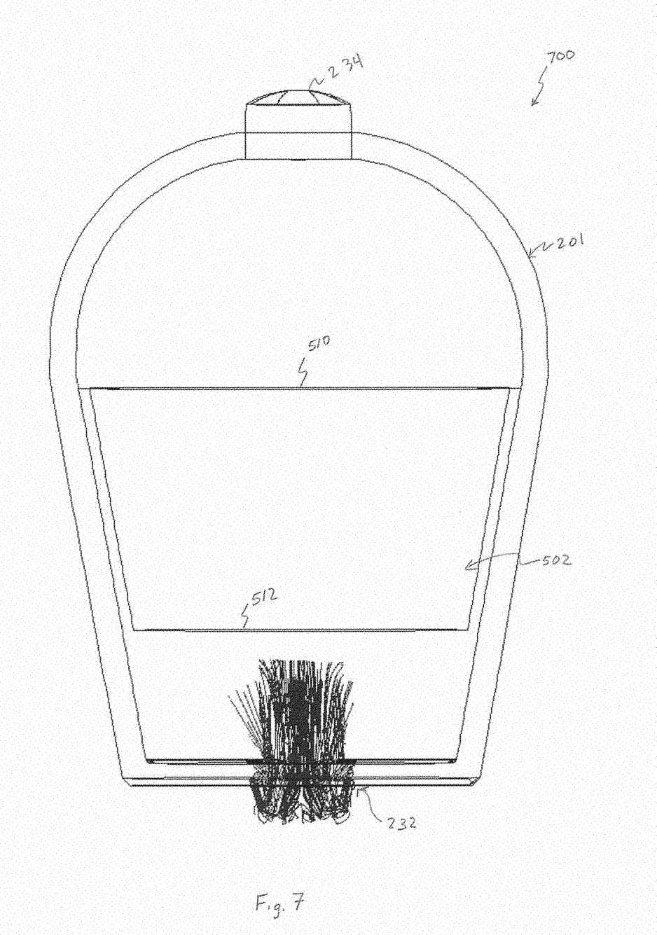

Referring now to FIG. 7 a side cutaway view of a computational fluid dynamics (CFD) model of a kamado style cooker without an internal diffuser operating in a calm environment. The cooker 700 of FIG. 7 is a computational model of a kamado style cooker modeled to be substantially similar to the cooker 200 described above without the snorkel 240 or the internal diffuser 516. The thin lines shown entering the body 201 through the bottom port 232 can be seen to proceed upward toward the fire bowl 502 and the fuel grate 512 with little spreading or diffusion. This results in the majority of airflow being directed to a specific concentrated region of the fuel grate 512 near the middle of the cooker body 201. This air flow results in faster and hotter combustion of fuel near the center of the grate 512 and slower and cooler fuel combustion near the outer rim. In addition to uneven heating and cooking temperatures within the cooker body 201 this results in uneven consumption of the fuel on the grate 512.

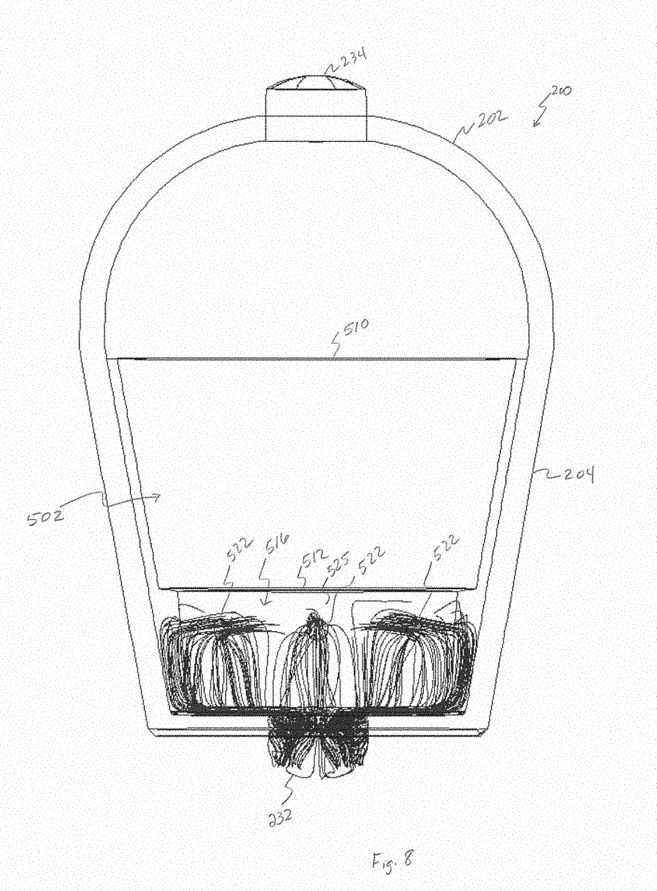

Referring now to FIG. 8, a side cutaway view of a CFD model of the kamado style cooker 200 described above is shown. The cooker 200 is shown operating in a calm environment. The snorkel 240 is not modeled or shown here as it does not have a substantial effect on airflow inside the body 201 under calm conditions (other effects and advantages described herein may be present regardless of conditions). The diffuser 516 can be seen to force airflow entering the port 232 to the outer edges of the body 201 and diffuser 512. The thin lines representing air flow can be seen radiating first outwardly and away from the port 232 before rising along the walls of the diffuser 512. Air flow is then inward and into the diffuser 512 via openings 522. The modeled air flow can be seen to be in a substantially even and diffuse manner compared to that of FIG. 7.

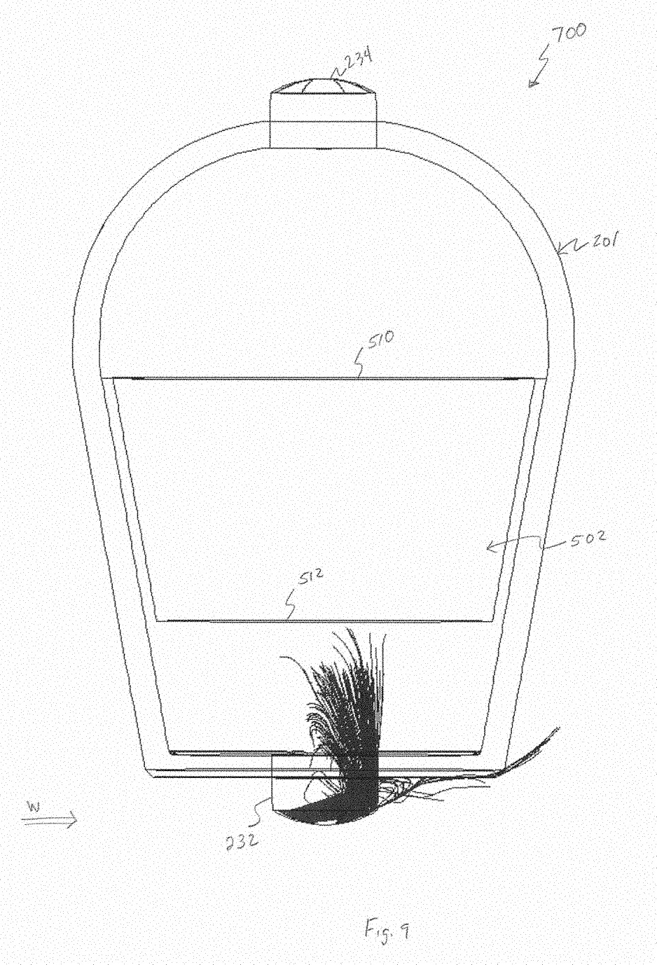

Referring now to FIG. 9 a side cutaway view of a CFD model of a kamado style cooker without an internal diffuser or snorkel operating in a four mile per hour wind is shown. The wind direction is represented by arrow W and is substantially horizontal in direction relative to the cooker body 201. The thin lines representing air flow into the cooker body 201 can be seen to be even more concentrated on a small region of the fuel grate 512 than in the calm conditions of FIG. 7. The problems with the concentrated air flow as described with respect to FIG. 7 are further exacerbated in the wind. Uneven heating, uneven fuel consumption, and flying ash and sparks are a non-exhaustive list of issues with the configuration of FIG. 9.

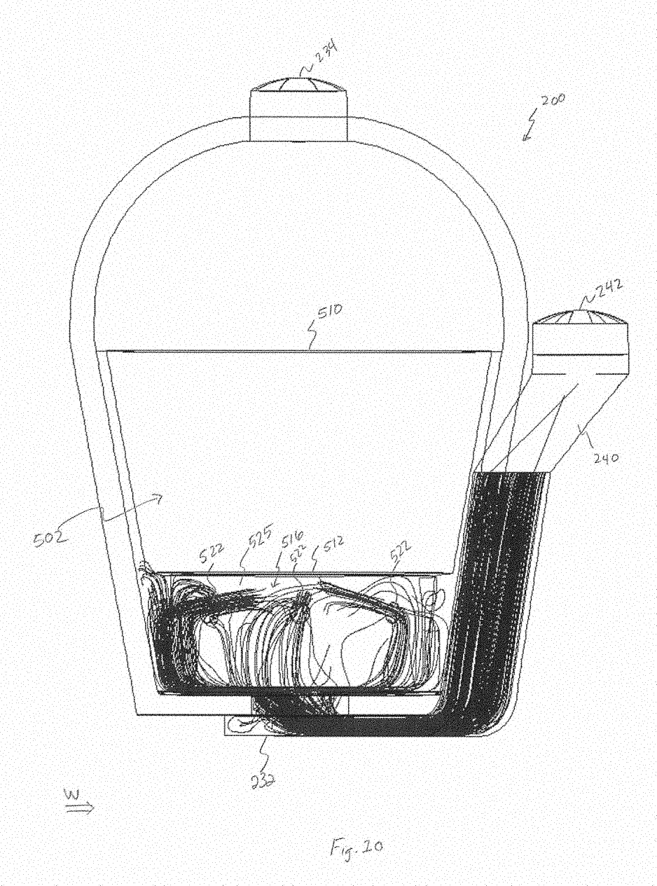

Referring now to FIG. 10 a side cutaway view of a CFD model of a kamado style cooker according to aspects of the present disclosure operating in a four mile per hour wind is shown. The cooker 200 is modeled as described above. The wind is once again a four mile per hour cross wind shown by arrow W to be substantially horizontal with respect to the cooker body 201. Here, air must travel down and through the snorkel 240 before reaching the intake port 232. Upon entering the cooker body 201 the air flow encountered the diffuser 516 as discussed above. Air is forced to the outside of the diffuser 516 and away from the port 232 before ascending to the perforations 522 in the cylindrical section 524 of the diffuser 516.

Comparing FIGS. 8 and 10 it can be seen that in windy conditions, air flow into the cooker body 201 via the snorkel 240 may be increased relative to a no-wind condition. It can further be observed that the air flow may be somewhat concentrated along the downwind side of the diffuser 522. Nevertheless, the diffuser 526 and snorkel 240 combination substantially even air flow to the fuel grate 512 compared to when they are absent (as in FIG. 9).

In addition to evening airflow, and therefore heating and fuel consumption inside the cooker 200, both the diffuser 516 and the snorkel 240 serve to arrest sparks or embers generated from the combustion of fuels taking place inside the cooker 200 from escaping. Not only are sparks or flying embers more likely to be generated in a windy condition, but they are much more likely to escape via a bare opening, damper, or port. Either the diffuser 516 or the snorkel 240 alone would reduce the likelihood of a spark or ember escaping. However, the further convenience of having the intake valve 242 positioned in an easily reachable location by the snorkel 240 allows the user to close the valve 242 when needed, virtually eliminating the chance for an ember or spark escape via the intake path and reducing such likely hood from the exhaust path even if the cooker 200 is opened.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Further, it should be noted that terms of approximation (e.g., “about”, “substantially”, “approximately”, etc.) are to be interpreted according to their ordinary and customary meanings as used in the associated art unless indicated otherwise herein. Absent a specific definition within this disclosure, and absent ordinary and customary usage in the associated art, such terms should be interpreted to be plus or minus 10% of the base value.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

If the specification or claims refer to “an additional” element, that does not preclude there being more than one of the additional element.

It is to be understood that where the claims or specification refer to “a” or “an” element, such reference is not be construed that there is only one of that element.

It is to be understood that where the specification states that a component, feature, structure, or characteristic “may”, “might”, “can” or “could” be included, that particular component, feature, structure, or characteristic is not required to be included.

Where applicable, although state diagrams, flow diagrams or both may be used to describe embodiments, the invention is not limited to those diagrams or to the corresponding descriptions. For example, flow need not move through each illustrated box or state, or in exactly the same order as illustrated and described.

Methods of the present invention may be implemented by performing or completing manually, automatically, or a combination thereof, selected steps or tasks.

The term “method” may refer to manners, means, techniques and procedures for accomplishing a given task including, but not limited to, those manners, means, techniques and procedures either known to, or readily developed from known manners, means, techniques and procedures by practitioners of the art to which the invention belongs.

The term “at least” followed by a number is used herein to denote the start of a range beginning with that number (which may be a ranger having an upper limit or no upper limit, depending on the variable being defined). For example, “at least 1” means 1 or more than 1. The term “at most” followed by a number is used herein to denote the end of a range ending with that number (which may be a range having 1 or 0 as its lower limit, or a range having no lower limit, depending upon the variable being defined). For example, “at most 4” means 4 or less than 4, and “at most 40%” means 40% or less than 40%.

When, in this document, a range is given as “(a first number) to (a second number)” or “(a first number)-(a second number)”, this means a range whose lower limit is the first number and whose upper limit is the second number. For example, 25 to 100 should be interpreted to mean a range whose lower limit is 25 and whose upper limit is 100. Additionally, it should be noted that where a range is given, every possible subrange or interval within that range is also specifically intended unless the context indicates to the contrary. For example, if the specification indicates a range of 25 to 100 such range is also intended to include subranges such as 26-100, 27-100, etc., 25-99, 25-98, etc., as well as any other possible combination of lower and upper values within the stated range, e.g., 33-47, 60-97, 41-45, 28-96, etc. Note that integer range values have been used in this paragraph for purposes of illustration only and decimal and fractional values (e.g., 46.7-91.3) should also be understood to be intended as possible subrange endpoints unless specifically excluded.

It should be noted that where reference is made herein to a method comprising two or more defined steps, the defined steps can be carried out in any order or simultaneously (except where context excludes that possibility), and the method can also include one or more other steps which are carried out before any of the defined steps, between two of the defined steps, or after all of the defined steps (except where context excludes that possibility).

Thus, the present invention is well adapted to carry out the objects and attain the ends and advantages mentioned above as well as those inherent therein. While the inventive device has been described and illustrated herein by reference to certain preferred embodiments in relation to the drawings attached thereto, various changes and further modifications, apart from those shown or suggested herein, may be made therein by those of ordinary skill in the art, without departing from the spirit of the inventive concept the scope of which is to be determined by the following claims.

What is claimed is:

1. A cooker comprising:
a cooker body having separable upper and lower portions with an exhaust vent and an intake port, respectively;
a fuel grate inside the lower portion;
a diffuser interposing the fuel grate and the air intake port; and
a snorkel providing an air pathway from the air intake port to a location outside the cooker body and above the fuel grate.

2. The cooker of claim 1, further comprising a fire bowl inside the lower portion on an opposite side of the fuel grate from the diffuser.

3. The cooker of claim 2, further comprising a cooking grate above the fire bowl.

4. The cooker of claim 1, wherein the diffuser presents a floor proximate the intake port that forces intake air radially away from the intake port inside the cooker body before it reaches the fuel grate.

5. The cooker of claim 4, wherein the diffuser provides a plurality of openings above the floor admitting air to the fuel grate.

6. The cooker of claim 5, wherein the diffuser provides a cylindrical section above the floor through which the plurality of openings is defined.

7. The cooker of claim 6, wherein the diffuser provides a curved section joining the cylindrical section to the floor to define an ash pan.

8. The cooker of claim 1, wherein the upper and lower portions join at a midportion of the cooker body and the snorkel terminates with an adjustable intake valve proximate the midportion.

9. The cooker of claim 4, wherein the snorkel terminates proximate a side shelf proximate the midportion of the cooker body.

10. The cooker of claim 5, further comprising an adjustable exhaust valve at the exhaust vent.

11. A cooker comprising:
a lower portion of a cooker body defining an air intake port through a bottom thereof;
a diffuser proximate the air intake presenting a solid surface toward the air intake port that disperses air entering the port laterally away from the port;
a fuel grate inside the lower portion of the cooker body above the diffuser;
a cooking grate above the fuel grate; and
an upper portion of the cooker body that selectively closes on the lower portion covering the cooking grate and opens from the lower portion exposing the cooking grate;
wherein a plurality of openings defined in walls of the diffuser above the solid surface diffuse air to an area below the fuel grate.

12. The cooker of claim 11, further comprising a snorkel that provides a closed air path between the air intake port and an area proximate an upper end of the lower portion of the cooker body.

13. The cooker of claim 12, further comprising a fire bowl interposing the fuel grate and the cooking grate.

14. The cooker of claim 13, further comprising:
an adjustable exhaust vent on the upper portion of the cooker body; and
an adjustable air intake vent on the snorkel opposite the air intake port on the lower portion of the cooker body.

15. The cooker of claim 14, wherein the air intake vent is located at approximately a height at which the upper portion of the cooker body joins the lower portion of the cooker body.

16. A cooker comprising:
a lower portion of a cooker body defining an air intake port through a bottom thereof;
a fire bowl suspended in the lower portion of the cooker body that has walls that are spaced apart from an adjacent portion of the lower portion of the cooker body and have a contour that mirrors the adjacent portion of the cooker body;
a fuel grate at a bottom of the fire bowl and suspended above the air intake port;
a cooking grate suspended proximate a top of the fire bowl;
an upper portion of the cooker body that selectively covers the cooking grate closing against the lower portion of the cooker body; and
a snorkel that defines a closed air path from the air intake port defined in the bottom of the lower portion of the cooker body to a vertical height proximate a midportion of the cooker body where the upper portion connects to the lower portion.

17. The cooker of claim 16, further comprising a diffuser below the fuel grate that has a solid plate that directs intake air from the intake port radially away from the intake port.

18. The cooker of claim 17, wherein the diffuser further comprises upright walls connected to and proceeding upwardly from an outer edge of the flat plate, the upright walls defining a plurality of perforations that admit intake air to the fuel grate.

19. The cooker of claim 18, wherein the snorkel provides an adjustable intake vent on an end thereof opposite the air intake port on the lower portion of the grill body.

20. The cooker of claim 19 wherein the air intake vent is vertically superior to the fire bowl.
